(19) United States
(12) Patent Application Publication
(10) Pub. No.: US 2026/0294727 A1
(43) Pub. Date: Oct. 1, 2026

(54) ELECTRIC SPINNING BACKSCRATCHER WITH INTEGRATED HARNESS SYSTEM

(71) Applicant: Jose Manuel Menendez, Coral Gables, FL (US)

(72) Inventor: Jose Manuel Menendez, Coral Gables, FL (US)

(21) Appl. No.: 19/097,158

(22) Filed: Apr. 1, 2025

(51) Int. Cl. A61H 7/00

(52) U.S. Cl. CPC A61H 7/004; A61H 2201/0192; A61H 2201/1215; A61H 2201/1614; A61H 2201/1623; A61H 2201/1652; A61H 2201/1654; A61H 2201/1671; A61H 2201/1685; A61H 2201/1692; A61H 2201/5005; A61H 2201/5007; A61H 2201/5035; A61H 2205/081

(57) ABSTRACT

An electric backscratcher assembly for providing automated skin stimulation is disclosed, including a housing containing an electric motor, a power source, and control electronics. A drive shaft is operatively coupled to the motor and connected to a rotating disc. The rotating disc includes a plurality of protrusions extending outwardly from its surface and is positioned within an integrally formed lip ring of the housing. The lip ring is configured to provide a protective barrier around the rotating disc during operation. A harness system is attached to the housing and configured to secure the backscratcher assembly to a user's back. The motor drives rotation of the disc to cause the protrusions to contact the user's back, providing automated scratching or massage.

### TECHNICAL FIELD

The embodiments disclosed herein generally relate to mechanical devices for personal care, and more specifically, to an electric spinning backscratcher with an integrated harness system for providing relief and comfort through automated scratching and massage.

### BACKGROUND

The relief of itching and discomfort on the skin surface is an important component of personal care and hygiene. Individuals often experience difficulty in reaching certain areas of the body, particularly the back, resulting in the need for assistance or the use of manual tools such as traditional backscratchers. These conventional backscratchers generally consist of a simple hand-held stick with a scratching end, requiring manual operation that may be cumbersome, ineffective, or tiring over prolonged use.

While some advancements have been made in the development of personal care devices, such as automated massagers or handheld scratching tools, these devices often lack versatility, user-friendliness, and ergonomic design. Many existing products require the user to maintain awkward postures or perform repetitive motions to achieve relief. Moreover, current solutions frequently fail to provide a consistent or controlled scratching or massaging experience, limiting their effectiveness in delivering comfort to the user.

Furthermore, there is a lack of personal care devices that combine automated scratching functionality with convenient and secure wearability. Existing solutions do not offer a hands-free experience that allows the user to comfortably and effortlessly receive consistent relief while engaging in other activities. This lack of innovation in combining automated mechanisms with ergonomic harness systems creates a need for an improved backscratcher device that enhances both convenience and user experience.

### SUMMARY OF THE INVENTION

This summary is provided to introduce a variety of concepts in a simplified form that is further disclosed in the detailed description of the embodiments. This summary is not intended for determining the scope of the claimed subject matter.

An electric spinning backscratcher that provides automated scratching and massaging to the skin surface. The device incorporates a rotating disc mechanism equipped with simulated hard rubber “fingernails,” designed to deliver consistent and controlled scratching or massaging sensations. The backscratcher is secured to the user's back through an integrated harness system, allowing for hands-free operation and targeted relief.

In one aspect, the backscratcher includes a disc, which rotates at variable speeds to accommodate user preference for intensity and comfort. The disc is mounted within a housing that is connected to a composite cloth harness featuring adjustable straps and ergonomic handles. The harness ensures that the device remains securely positioned on the user's back during use, providing reliable and consistent contact with the skin surface.

In one aspect, the device is powered by a rechargeable battery system and includes conveniently located control buttons on the handles of the harness. These buttons allow the user to easily power the device on and off, as well as adjust the rotational speed of the disc to customize the scratching or massaging experience. The intuitive controls and wireless functionality enhance user convenience and mobility.

In one aspect, the electric spinning backscratcher can be used for general massage applications to promote relaxation and stress relief. The simulated “fingernail” design and variable speed settings enable a range of therapeutic uses, from gentle stimulation to more vigorous massage.

In one aspect, the design of the electric spinning backscratcher makes it particularly beneficial for individuals with limited mobility or flexibility, as it eliminates the need for manual effort or assistance. By combining automated operation with an ergonomic harness system, the device offers a practical and effective solution for self-care, enabling users to experience comfort and relief independently.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the electric spinning backscratcher assembled, according to some embodiments;

FIG. 2 illustrates an exploded view of the backscratcher assembly showing the base, motor, battery, control unit, and rotating disc, according to some embodiments;

FIG. 3 illustrates a perspective view of the rotating disc with a plurality of protrusions configured to contact the user's skin, according to some embodiments;

FIG. 4 illustrates a cross-sectional view of the backscratcher assembly showing the internal motor, battery housing, and rotating disc attachment mechanism, according to some embodiments; and

FIG. 5 illustrates a perspective view of the harness system used to secure the backscratcher assembly to the user, according to some embodiments.

### DETAILED DESCRIPTION OF THE INVENTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments re-side primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein relate to a wearable electric spinning backscratcher assembly that provides automated relief for skin irritation and functions as a massaging device. The backscratcher assembly may be particularly beneficial for individuals with limited mobility, those who experience chronic itching, or those seeking a hands-free massage solution.

The backscratcher assembly is designed with a universal fit system, allowing it to be comfortably secured to users of varying body types and sizes. To provide this universal fit, the harness system includes adjustable straps that can be lengthened or shortened as needed. In some embodiments, the harness system may be provided as a set or kit including multiple strap configurations to accommodate different torso lengths and body contours. For example, the straps may be offered in various widths or padded versions to enhance user comfort during extended use.

The rotating disc may also be provided in a variety of sizes and surface configurations. In some embodiments, the device includes interchangeable discs, each having different protrusion lengths, densities, and materials. This allows the user to select a disc configuration tailored to their comfort preferences or therapeutic needs.

In some embodiments, spacer components may be included to adjust the distance between the rotating disc and the user's back. These spacers enable the user to fine-tune the depth of contact, ensuring effective operation for individuals with varying back curvature or sensitivity. The spacers may be removably attachable to the housing via a threaded engagement or snap-fit connection.

The backscratcher assembly may also include optional covers or sleeves for the protrusions. These covers may be fabricated from different materials, such as silicone or antimicrobial coatings, to provide additional hygiene or tactile options. The covers may be color-coded for easy identification and may be removable for cleaning or replacement.

In some embodiments, a carrying case or storage bag may be provided to protect the backscratcher assembly when not in use. The carrying case may include compartments for holding additional discs, straps, spacers, and a charging cable, allowing for convenient transport and organization of the components as part of a complete kit.

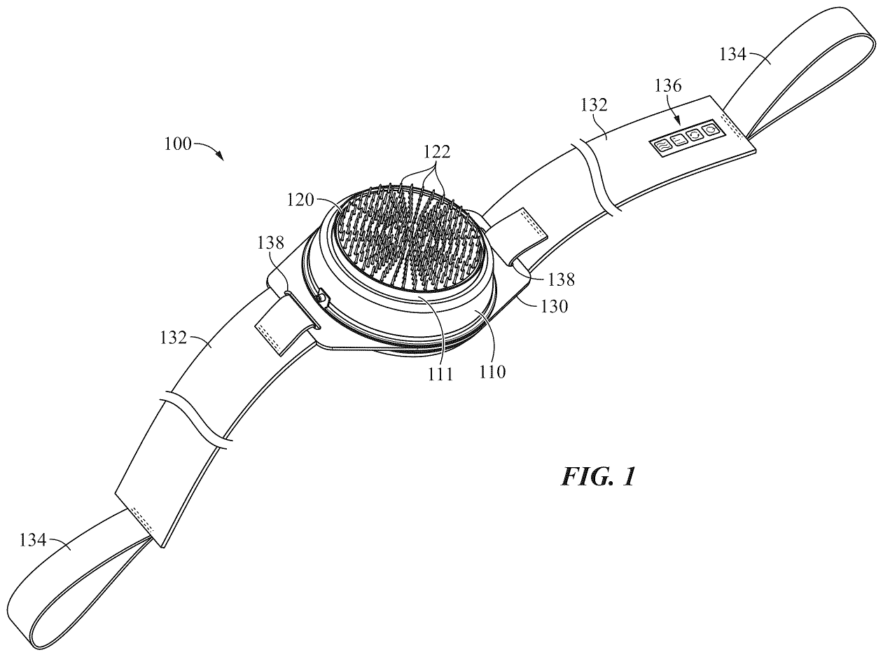

Referring now to FIG. 1, a perspective view of the backscratcher assembly 100 is illustrated in an assembled configuration. The backscratcher assembly 100 includes a housing 110, a rotating disc 120 mounted on the housing, and a plurality of protrusions 122 extending from the rotating disc 120. The protrusions 122 are configured to contact the user's skin to provide a scratching or massaging effect. The assembly 100 further includes an adjustable harness system 130, having straps 132 and handles 134, which secures the housing 110 to the user's back during operation.

In some embodiments, the housing 110 includes an integrally formed lip ring 111 extending radially outward around the perimeter of the mounting area for the rotating disc 120. The lip ring 111 is designed to serve as a protective barrier that prevents interference between the rotating disc 120 and surrounding components or garments during operation. Although prototype versions may include fasteners such as screws to attach the lip ring 111, the final embodiment integrates this feature directly into the molded structure of the housing 110 for enhanced durability, aesthetics, and ease of manufacturing.

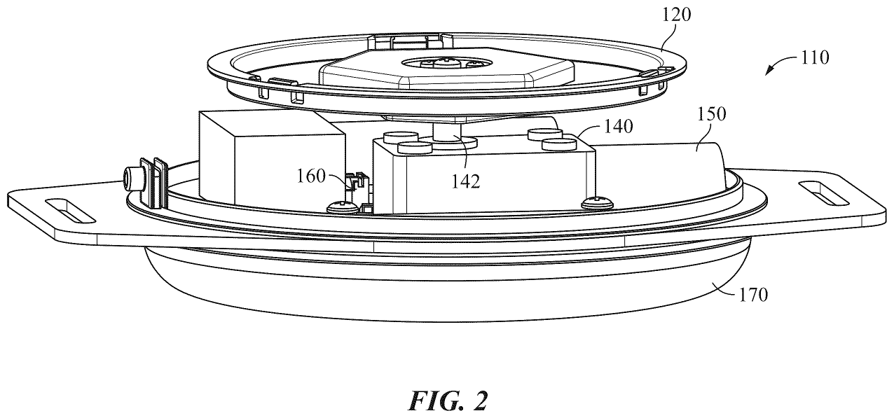

FIG. 2 illustrates an exploded view of the backscratcher assembly 100. The housing 110 encloses an electric motor 140 and a rechargeable battery 150. The rotating disc 120 is mechanically connected to the motor 140 via a drive shaft 142, enabling the disc 120 to rotate when the motor is powered. Control electronics 160 are also housed within the housing 110 and are electrically connected to the motor 140 and battery 150. The control electronics 160 regulate motor speed and power through input received from control buttons 136 located on the handles 134 of the harness system 130.

In some embodiments, the housing 110 may be constructed from a lightweight polymer or composite material to minimize the weight of the device, thereby improving user comfort during use. The rotating disc 120 may be fabricated from a durable, flexible material suitable for repeated skin contact without causing irritation.

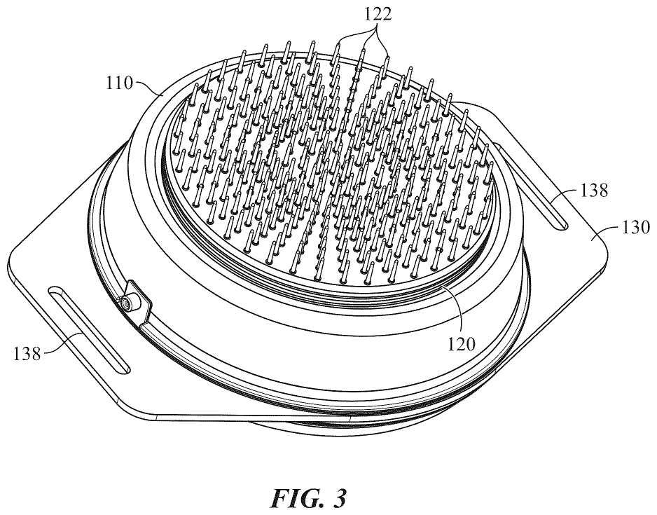

FIG. 3 illustrates a perspective view of the rotating disc 120, showing the plurality of protrusions 122 arranged in concentric rings across the surface of the disc 120. The protrusions 122 may be uniformly spaced and sized to ensure consistent contact with the skin during rotation. In some embodiments, the protrusions 122 are made from thermoplastic elastomer (TPE) or silicone rubber to provide a balance between firmness and flexibility, enhancing the comfort and effectiveness of the scratching or massaging action.

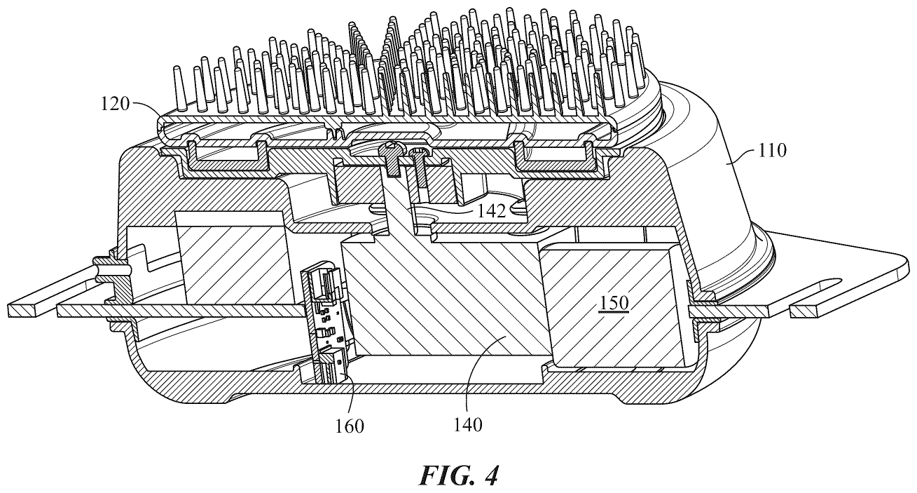

FIG. 4 illustrates a cross-sectional view of the backscratcher assembly 100. The rotating disc 120 is shown mounted on the drive shaft 142 of the electric motor 140, which is seated within the internal motor mount 144 of the housing 110. The rechargeable battery 150 is positioned adjacent to the motor 140 and is connected via wiring 162 to the control electronics 160. The housing 110 may be sealed with a cover plate 170 that protects the internal components from dust, moisture, and debris.

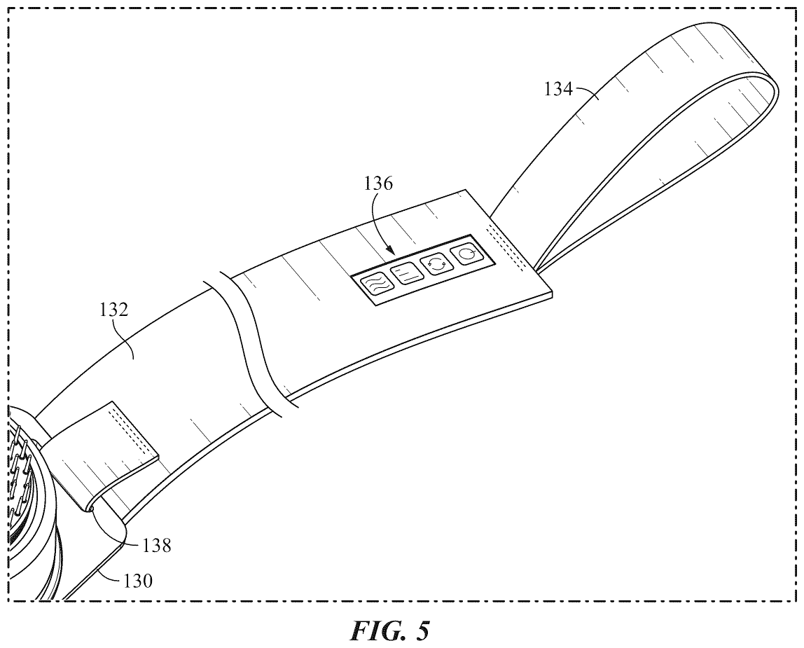

FIG. 5 illustrates a perspective view of the harness system 130. The harness system 130 includes two shoulder straps 132, which are adjustable to accommodate various body sizes. The straps 132 connect to the housing 110 at attachment points 138 and are designed to hold the backscratcher assembly 100 securely against the user's back. Each strap 132 includes an integrated handle 134 that houses control buttons 136. The control buttons 136 allow the user to turn the device on or off and adjust the speed of rotation of the disc 120. In some embodiments, the harness system 130 may include a quick-release buckle 139 for ease of donning and doffing the assembly.

In some embodiments, the motor 140 may offer multiple speed settings to allow the user to customize the intensity of the scratching or massage action. The control electronics 160 may include a microcontroller programmed to provide additional features such as auto-shutoff after a preset time period, low battery alerts, or a massage mode that alternates between different speeds.

In some embodiments, the battery 150 may be a lithium-ion or lithium-polymer battery pack, offering rechargeable functionality via a charging port 172 positioned on the side of the housing 110. The battery 150 may be designed to provide continuous operation for a period of 30 minutes to 1 hour, depending on the selected speed setting.

The harness system 130 may also be designed with ergonomic padding at critical contact points to enhance comfort during prolonged use. The straps 132 may be fabricated from a breath-able, moisture-wicking material to minimize heat retention and improve the user experience.

The backscratcher assembly 100 is designed to be worn on the back but may be adapted for use on other parts of the body, such as the thighs, calves, or shoulders, by repositioning the harness system 130. In some embodiments, additional attachments or accessories may be provided to expand the functionality of the device.

The materials selected for the rotating disc 120 and protrusions 122, along with the control mechanisms and adjustable harness system 130, provides an automated, hands-free solution for skin relief and massage, offering improved user convenience and comfort over traditional manual backscratchers.

As used herein, the term “protrusions” refers to a series of raised elements extending outwardly from a surface of the rotating disc. The protrusions are configured to contact and stimulate the user's skin, providing a scratching or massaging sensation. In various embodiments, the protrusions may be formed from flexible materials such as thermoplastic elastomer (TPE), silicone, or other biocompatible polymers. The shape, length, and spacing of the protrusions may vary depending on the desired intensity and purpose of the skin stimulation.

Unless otherwise defined, all technical and scientific terms used herein have the same meaning as commonly understood by one of ordinary skill in the art to which this invention be-longs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. An electric backscratcher assembly for providing automated skin stimulation, comprising:
a housing having an integrally formed lip ring;
an electric motor positioned within the housing;
a drive shaft operatively coupled to the motor;
a rotating disc coupled to the drive shaft, the rotating disc having a plurality of protrusions extending outwardly from a surface of the rotating disc, the rotating disc positioned within the lip ring;
power source positioned within the housing and operatively connected to the motor; and
a harness system attached to the housing and configured to secure the backscratcher assembly to a user's back, wherein the motor drives rotation of the rotating disc to cause the plurality of protrusions to contact the user's back during operation.

2. The electric backscratcher assembly of claim 1, wherein the harness system comprises a pair of adjustable straps configured to be secured over a user's shoulders.

3. The electric backscratcher assembly of claim 1, wherein the harness system includes handles each having control buttons configured to control the operation of the motor.

4. The electric backscratcher assembly of claim 1, wherein the rotating disc includes interchangeable disc components having different protrusion configurations.

5. The electric backscratcher assembly of claim 4, wherein the protrusions of the rotating disc are fabricated from a thermoplastic elastomer (TPE) or silicone rubber material.

6. The electric backscratcher assembly of claim 1, further comprising spacer components removably attached between the housing and the rotating disc to adjust a distance between the rotating disc and the user's back.

7. The electric backscratcher assembly of claim 1, wherein the power source is a rechargeable lithium-ion or lithium-polymer battery.

8. The electric backscratcher assembly of claim 7, wherein the battery is rechargeable via a charging port positioned on an exterior surface of the housing.

9. The electric backscratcher assembly of claim 1, further comprising control electronics positioned within the housing and configured to regulate motor speed.

10. The electric backscratcher assembly of claim 9, wherein the control electronics include a microcontroller programmed with multiple speed settings.

11. The electric backscratcher assembly of claim 1, wherein the harness system further includes a quick-release buckle to facilitate removal of the backscratcher assembly.

12. An electric backscratcher system for providing automated scratching and massage, comprising:
a housing containing a motor assembly and control electronics;
a drive shaft extending from the motor assembly;
a rotating disc coupled to the drive shaft, the rotating disc having a plurality of protrusions configured to contact a user's skin;
harness system configured to secure the housing to a user, the harness system including adjustable straps and control handles with input buttons;
a power source operatively connected to the motor assembly and the control electronics; and
one or more interchangeable disc components having differing protrusion configurations, wherein the rotating disc is configured to rotate in response to user input received from the input buttons on the harness system.

13. The electric backscratcher system of claim 12, wherein the control electronics are configured to provide automatic shut-off after a pre-determined time interval.

14. The electric backscratcher system of claim 12, wherein the plurality of protrusions are constructed from an antimicrobial material.

15. The electric backscratcher system of claim 12, further comprising spacer components configured to adjust a distance between the rotating disc and the housing.

16. The electric backscratcher system of claim 12, wherein the harness system includes padded regions to enhance comfort during use.

17. The electric backscratcher system of claim 12, further comprising a carrying case configured to hold the backscratcher system and accessories including interchangeable discs and spacers.

18. The electric backscratcher system of claim 12, wherein the rotating disc is removably coupled to the drive shaft via a threaded engagement.

19. The electric backscratcher system of claim 12, wherein the power source is a rechargeable battery, and the housing includes an indicator light to signal low battery status.

20. The electric backscratcher system of claim 12, wherein the harness system is adjustable to position the rotating disc at different locations along a user's back.
